(19) United States
(12) Patent Application Publication
(10) Pub. No.: US 2026/0259047 A1
(43) Pub. Date: Sep. 3, 2026

(54) METHOD AND SYSTEM FOR MEASURING LUBRICATION FILM THICKNESS OF SLIDING NEARING BASED ON ULTRASONIC PROPORTIONAL COEFFICIENT

(71) Applicant: XI'AN JIAOTONG UNIVERSITY, Xi'an (CN)

(72) Inventors: Pan DOU, Xi'an (CN); Yumin ZHANG, Xi'an (CN); Yaguo LEI, Xi'an (CN); Tonghai WU, Xi'an (CN); Peiping YANG, Xi'an (CN)

(21) Appl. No.: 19/654,687

(22) Filed: Apr. 22, 2026

(30) Foreign Application Priority Data
May 12, 2025 (CN) 202510605340.5

(51) Int. Cl. G01B 17/02; G01N 29/07; G01N 29/11; G01N 29/44

(52) U.S. Cl. CPC G01B 17/025; G01N 29/075; G01N 29/11; G01N 29/4427; G01N 29/449; G01N 2291/012; G01N 2291/015; G01N 2291/0237; G01N 2291/02854; G01N 2291/2696

(57) ABSTRACT

A method and system for measuring a lubrication film thickness of a sliding bearing based on an ultrasonic proportional coefficient includes the following step. A first proportional coefficient between an echo signal reflected from a bearing bush-air interface and an echo signal reflected from a substrate-liner interface is calculated to obtain a comprehensive response coefficient of an acoustic wave in a transition bonding layer between a substrate and a liner, and a propagation law of the acoustic wave in the transition bonding layer is represented. Based on an echo signal reflected from a lubrication film and the echo signal reflected from the substrate-liner interface, a second proportional coefficient is constructed. Based on the second proportional coefficient and the comprehensive response coefficient, a reflection coefficient of the lubrication film is calculated. The lubrication film thickness is obtained through a resonance model method or a composite model method.

### CROSS-REFERENCE TO RELATED APPLICATIONS

This application claims the benefit of priority from Chinese Patent Application No. 202510605340.5, filed on May 12, 2025. The content of the aforementioned application, including any intervening amendments thereto, is incorporated herein by reference in its entirety.

### TECHNICAL FIELD

This application relates to lubricating state monitoring of a friction pair in a machinery system, and more particularly to a method and system for measuring a lubrication film thickness of a sliding bearing based on an ultrasonic proportional coefficient.

### BACKGROUND

A sliding bearing is a critical supporting component in large rotating machinery, such as hydraulic power generation unit and a thermal power generation unit, which supports a load of a rotating part through utilizing hydrodynamic effect based on a lubrication thin film formed between a bearing bush and a mirror plate. In an actual industrial operating environment, a lubrication film thickness is influenced by various factors, such as load variations, speed fluctuations, and temperature changes, which significantly affect bearing performance aspects such as friction, wear, and heat generation. Proper lubrication conditions ensure smooth bearing operation, effectively reduce friction, and prevent failures caused by overheating, which significantly extends a service life of the sliding bearing. Therefore, accurate and reliable monitoring for the lubrication film thickness is of great significance for optimizing bearing performance design and preventing early lubrication failures in equipment.

For the measurement of the lubrication film thickness, an ultrasonic method stands out due to its unique non-invasion advantages. The ultrasonic method can penetrate metallic materials, enable non-destructive testing of the lubrication film thickness without altering material or structural properties of the components. In addition, the ultrasonic method has a relatively wide measurement range and can achieve measurements at sub-micron levels under minimal conditions. Under ideal circumstances, the ultrasonic method has high measurement accuracy, and can provide reliable assurance for precise monitoring of lubrication film thickness. Therefore, the ultrasonic method is regarded as an efficient, reliable, and highly promising method, which has already been widely applied in product-level bench tests for large-scale thrust sliding bearings, large-scale wind power rolling bearings, aviation fuel pumps, and engine piston ring systems, and gained satisfactory effects.

In the ultrasonic method, the lubrication film thickness is calculated through measuring a lubrication film reflection coefficient, which is a ratio of a reflected signal of a lubrication film to an incident signal of the lubrication film. Since the incident signal cannot be directly captured, it is usually necessary to disassemble the equipment and expose a friction pair surface to air, and the incident signal is approximated by measuring a reflected echo from an air interface as a reference signal. However, during long-term monitoring of the equipment, an ultrasonic sensor is embedded in a bearing bush for extended periods and is susceptible to interference from factors, such as temperature, vibration, and contamination, resulting in changes in bonding force between the ultrasonic sensor and a substrate, which further leads to changes in an ultrasonic reflection echo and measurement errors of the lubrication film thickness. Therefore, a current research challenge is that how to address an issue of reference signal variation due to changes in the bonding force between the ultrasonic sensor and the substrate, and improve a robustness of the ultrasonic method for measuring the lubrication film thickness.

### SUMMARY

In order to solve the deficiencies in the prior art described above, this application provides a method and system for measuring a lubrication film thickness of a sliding bearing based on an ultrasonic proportional coefficient, so as to solve problems of frequent updates of reference signals in practical engineering applications and poor robustness of existing methods for measuring the lubrication film thickness of the sliding bearing, and achieve accurate measurement of the lubrication film thickness of the sliding bearing.

Technical solutions of this application are described as follows.

A method for measuring a lubrication film thickness of a sliding bearing based on an ultrasonic proportional coefficient, the sliding bearing comprising a runner plate, a liner, a lubrication film and a substrate, and the method comprising:
calculating a first proportional coefficient, wherein the first proportional coefficient is a proportional coefficient between an echo signal reflected from a liner-air interface and an echo signal reflected from a substrate-liner interface; and based on the first proportional coefficient, obtaining a comprehensive response coefficient of an acoustic wave in a transition bonding layer between the substrate and the liner;
based on an echo signal reflected from the lubrication film and the echo signal reflected from the substrate-liner interface, constructing a second proportional coefficient;
based on the second proportional coefficient and the comprehensive response coefficient, obtaining a reflection coefficient of the lubrication film; and dividing the reflection coefficient of the lubrication film into an amplitude spectrum of the reflection coefficient of the lubrication film and a phase spectrum of the reflection coefficient of the lubrication film; and
based on the amplitude spectrum and the phase spectrum, calculating a thickness of the lubrication film.

In an embodiment, the comprehensive response coefficient is obtained through steps of:
removing the lubrication film from the sliding bearing, and collecting the echo signal B_{ca1}(f) reflected from the liner-air interface;
based on the echo signal B_{ca1}(f) and the echo signal B_{sc1}(f) reflected from the substrate-liner interface, constructing a third proportional coefficient K₁(f); obtaining an amplitude spectrum |K₁(f)| of the third proportional coefficient K₁(f) and a phase spectrum Φ_{K1}(f) of the third proportional coefficient K₁(f); and obtaining an amplitude spectrum |CR(f)| of the comprehensive response coefficient and a phase spectrum Φ_{CR}(f) of the comprehensive response coefficient.

In an embodiment, the amplitude spectrum |CR(f)| of the comprehensive response coefficient and the phase spectrum Φ_{CR}(f) of the comprehensive response coefficient are respectively expressed as:

$$\\ \vert CR ( f ) \vert = \frac{\vert {W}_{sc} \vert \vert {W}_{cs} \vert}{\vert {V}_{sc} \vert} = \frac{\vert {K}_{1} ( f ) \vert}{exp ( - 2 {α}_{c} {d}_{c} )} ; and \\ {Φ}_{CR} ( f ) = {φ}_{W \_ sc} + {φ}_{W \_ cs} - {φ}_{V \_ sc} = {Φ}_{K 1} ( f ) - 2 π {ft}_{c} ;$$

wherein |W_{sc}| represents an amplitude of a transmission coefficient of the substrate-liner interface; |W_{cs}| represents an amplitude of a transmission coefficient of a liner-substrate interface; α_{c} represents an attenuation coefficient of an ultrasonic wave in the liner; K₁(f) represents the third proportional coefficient; d_{c} represents a thickness of the liner; |V_{sc}| represents an amplitude of a reflection coefficient of the substrate-liner interface; t_{c} represents a propagation time of the ultrasonic wave in the liner; φ_{W_sc} represents a phase of the transmission coefficient of the substrate-liner interface; φ_{W_cs} represents a phase of the transmission coefficient of the liner-substrate interface; and φ_{V_sc} represents a phase of the reflection coefficient of the substrate-liner interface.

In an embodiment, step of constructing the second proportional coefficient based on the echo signal reflected from the lubrication film and the echo signal reflected from the substrate-liner interface:
based on the echo signal B_{co2}(f) reflected from the lubrication film and the echo signal B_{sc2}(f) reflected from the substrate-liner interface, constructing the second proportional coefficient K₂(f), and dividing the second proportional coefficient K₂(f) into an amplitude spectrum |K₂(f)| of the second proportional coefficient K₂(f) and a phase spectrum Φ_{K2}(f) of the second proportional coefficient K₂(f).

In an embodiment, the amplitude spectrum |K₂(f)| and the phase spectrum Φ_{K2}(f) are respectively expressed as:

$$\\ \vert {K}_{2} ( f ) \vert = \frac{\vert {W}_{sc} \vert \vert {W}_{cs} \vert exp ( - 2 {α}_{c} {d}_{c} ) \vert R ( f ) \vert}{\vert {V}_{sc} \vert} ; and \\ {Φ}_{K 2} ( f ) = {Φ}_{R} ( f ) + 2 π {ft}_{c} + {φ}_{W \_ sc} + {φ}_{W \_ cs} - {φ}_{V \_ sc} ;$$

wherein |R(f)| represents an amplitude of the reflection coefficient of the lubrication film; Φ_{R}(f) represents a phase of the reflection coefficient of the lubrication film; |W_{sc}| represents an amplitude of a transmission coefficient of the substrate-liner interface; |W_{cs}| represents an amplitude of a transmission coefficient of a liner-substrate interface; α_{c} represents an attenuation coefficient of an ultrasonic wave in the liner; d_{c} represents a thickness of the liner; |V_{sc}| represents an amplitude of a reflection coefficient of the substrate-liner interface; f represents a frequency; t_{c} represents a propagation time of the ultrasonic wave in the liner; φ_{W_sc} represents a phase of the transmission coefficient of the substrate-liner interface; φ_{W_cs} represents a phase of the transmission coefficient of the liner-substrate interface; and φ_{V_sc} represents a phase of the reflection coefficient of the substrate-liner interface.

In an embodiment, the amplitude spectrum |R(f)| of the reflection coefficient of the lubrication film and the phase spectrum Φ_{R}(f) of the reflection coefficient of the lubrication film are respectively expressed as:

$$\vert R ( f ) \vert = \frac{\vert {K}_{2} ( f ) \vert}{\vert CR ( f ) \vert exp ( - 2 {α}_{c} {d}_{c} )} ; and$$

$${Φ}_{R} ( f ) = {Φ}_{K 2} ( f ) - 2 π f {t}_{c} - {Φ}_{C R} ( f ) ;$$

wherein |K₂(f)| represents an amplitude spectrum of the second proportional coefficient; Φ_{K2}(f) represents a phase spectrum of the second proportional coefficient; |CR(f)| represents an amplitude spectrum of the comprehensive response coefficient; α_{c} represents an attenuation coefficient of an ultrasonic wave in the liner; d_{c} represents a thickness of the liner; f represents a frequency; t_{c} represents a propagation time of the ultrasonic wave in the liner; and Φ_{CR}(f) represents a phase spectrum of the comprehensive response coefficient.

In an embodiment, the lubrication film thickness is calculated through steps of:
when there is a local minimum minimal value point in the amplitude spectrum |R(f)| of the reflection coefficient of the lubrication film or there is a zero-crossing point in the phase spectrum Φ_{R}(f) of the reflection coefficient of the lubrication film, calculating the thickness h of the lubrication film through a resonance model method; and
when there is no local minimum point in the amplitude spectrum |R(f)| of the reflection coefficient of the lubrication film and there is no zero-crossing point in the phase spectrum Φ_{R}(f) of the reflection coefficient of the lubrication film, calculating the thickness h of the lubrication film through a composite model method.

In an embodiment, the resonance model method is expressed as:

$$h = \frac{{c}_{o} m}{2 {f}_{m}} ;$$

wherein m represents a resonance order; fₘ represents a frequency at the local minimum point or the zero-crossing point; and cₒ represents a propagation speed of an ultrasonic wave in the lubrication film.

In an embodiment, the composite model method is expressed as:

$$h = - \frac{{c}_{o}}{4 π f} atan ( \frac{\vert R ( f ) \vert \cdot sin ( {Φ}_{R} ( f ) ) \cdot ( 1 - {V}_{c o}^{2} )}{\begin{matrix}- {V}_{c o} - {\vert R ( f ) \vert}^{2} \cdot {V}_{c o} + \vert R ( f ) \vert \cdot cos ( {Φ}_{R} ( f ) ) + \\ \vert R ( f ) \vert \cdot cos ( {Φ}_{R} ( f ) ) \cdot {V}_{c o}^{2}\end{matrix}} ) ;$$

wherein V_{co} represents a reflection coefficient of a liner-lubrication film interface; Vₒₛ represents a reflection coefficient of a lubrication film-runner plate interface; cₒ represents a propagation speed of an ultrasonic wave in the lubrication film; and f represents a frequency.

In a second aspect, a system for measuring an ultrasonic proportional coefficient of a lubrication film thickness of a sliding bearing is provided, comprising:
a first processor;
a second processor;
a third processor; and
a fourth processor;
wherein the first processor is configured to calculate a first proportional coefficient, and obtain a comprehensive response coefficient of an acoustic wave in a transition bonding layer between a substrate and a liner, wherein the first proportional coefficient is a proportional coefficient between an echo signal reflected from a liner-air interface and an echo signal reflected from a substrate-liner interface;
the second processor is configured to construct a second proportional coefficient based on an echo signal reflected from a lubrication film and the echo signal reflected from the substrate-liner interface;
the third processor is configured to divide e a reflection coefficient of the lubrication film into an amplitude spectrum and a phase spectrum based on the second proportional coefficient and the comprehensive response coefficient; and
the fourth processor is configured to calculate and output a thickness of the lubrication film based on the amplitude spectrum and the phase spectrum.

In a third aspect, a computer device is provided, comprising a memory, a processor, and a computer program stored in the memory and can be executed in the processor; and when the processor executes the computer program, the steps of the method for measuring the lubrication film thickness of the sliding bearing based on the ultrasonic proportional coefficient above are realized.

In a fourth aspect, a computer-readable storage medium is provided, comprising a computer program; wherein the computer program is executed to realize the steps of the method for measuring the lubrication film thickness of the sliding bearing based on the ultrasonic proportional coefficient above.

In a fifth aspect, a chip is provided, comprising a memory, a processor, and a computer program stored in the memory and can be executed in the processor; and when the processor executes the computer program, the steps of the method for measuring the lubrication film thickness of the sliding bearing based on the ultrasonic proportional coefficient above are realized.

In a sixth aspect, an electronic device is provided, comprising a computer program; and when the electronic device executes the computer program, the steps of the method for measuring the lubrication film thickness of the sliding bearing based on the ultrasonic proportional coefficient above are realized.

Compared to the prior art, this application has the following beneficial effects.

The method of the present disclosure utilizes a sensor to collect the echo signal reflected from the lubrication film and the echo signal reflected from the substrate-liner interface, so as to construct the second proportional coefficient, and calculates the reflection coefficient of the lubrication film based on the second proportional coefficient and the comprehensive response coefficient. The method of the present disclosure is not affected by change in a bonding force between the sensor and the substrate, solves problems of reference signal changes caused by interference from external factors such as temperature, vibration and pollution, and improves a robustness of the method for measuring the lubrication film thickness of the sliding bearing, which has important engineering significance for long-term reliable monitoring of the lubrication film thickness of a friction pair of the sliding bearing.

The method of the present disclosure, by calculating the first proportional coefficient between the echo signal reflected from the liner-air interface and the echo signal reflected from the substrate-liner interface to obtain the comprehensive response coefficient, can characterize a propagation law of the acoustic wave in the transition bonding layer between the substrate and the liner, which provide a basis for calculating the lubrication film thickness based on the first proportional coefficient and the second proportional coefficient.

In the method of the present disclosure, step of based on the echo signal reflected from the lubrication film and the echo signal reflected from the substrate-liner interface, constructing the second proportional coefficient can offset effects on ultrasonic propagation from all processes prior to the substrate-liner interface, which effectively avoids issue of reference signal changes caused by changes of the bonding force between the sensor and the substrate.

The method of the present disclosure, by comparing the echo signal reflected from the liner-air interface and the echo signal reflected from the substrate-liner interface, quantifies inherent reflection characteristics of the interfaces, and provides a reference for subsequent signal analysis of the lubrication film. The method of the present disclosure also reduces measurement interference caused by hardware variations such as ultrasonic probes and coupling agents, and enhances data consistency.

The method of the present disclosure suppresses common-mode noises based on proportional operations, prevent a weak signal of the lubrication film from being obscured due to ultrasonic energy attenuation, and enhances detection sensitivity for films.

The method of the present disclosure enables independent extraction of the acoustic properties of the lubrication film. In this method, the amplitude spectrums, showing acoustic impedance differences, and the phase spectrums, showing propagation time, are analyzed separately to prevent cross-coupling interference. The method performs analysis in a frequency domain to reduce influence of time-domain noise, so as to improve data reliability.

The method of the present disclosure, by integrating information of the amplitudes and phases, utilizes sound velocities, reflection time, or a dispersion relation model to accurately obtain the thickness. This method can handle non-uniform film layers or dynamic lubrication conditions, so as to enhance engineering applicability.

It can be understood that beneficial effects from the second to the sixth aspects mentioned above can be referred to the relevant descriptions for the first aspect, which are not elaborated herein.

In summary, the present disclosure systematically eliminates interfering factors through stepwise processing from interface characteristics to signals of the lubrication film. The ultrasonic technology does not require damage to the bearing structure, and is suitable for online and real-time monitoring and life assessment, thereby facilitating reducing potential security risks. Based on the information of the amplitudes and phases, the limitations of single-parameter measurement are broken through. Through stepwise signal processing and feature extraction, accuracy and robustness of the measurement of the lubrication film thickness of the sliding bearing are significantly improved, making it suitable for high-precision industrial inspection scenarios.

The technical solutions of the present disclosure are further described in detail through the accompanying drawings and embodiments.

### BRIEF DESCRIPTION OF THE DRAWINGS

In order to illustrate the technical solutions of this application more clearly, the accompanying drawings required in the description of embodiments will be briefly introduced below. It is obvious that the following accompanying drawings only show some embodiments of this application, and for those of ordinary skill in the art, other relevant accompanying drawings can also be obtained according to these drawings without making creative effort.

FIG. 1 is a signal processing flowchart of a high-robustness method for measuring a lubrication film thickness of a sliding bearing based on an ultrasonic proportional coefficient according to an embodiment of the present disclosure.

FIG. 2a is a schematic diagram of ultrasonic propagation in a friction pair of the sliding bearing in a pre-test stage according to an embodiment of the present disclosure.

FIG. 2b is a schematic diagram of ultrasonic propagation in the friction pair of the sliding bearing in an actual testing stage according to an embodiment of the present disclosure.

FIG. 3 is a schematic diagram of a calibration test bench for the lubrication film thickness and an ultrasonic measurement system according to an embodiment of the present disclosure.

FIG. 4 shows time-domain waveforms of a first reference signal 1 and a second reference signal 2 according to an embodiment of the present disclosure.

FIG. 5a is an amplitude spectrum of a reflection coefficient of a lubrication film according to an embodiment of the present disclosure.

FIG. 5b is a phase spectrum of the reflection coefficient of the lubrication film according to an embodiment of the present disclosure.

FIG. 6a shows a calculation result of the lubrication film thickness in a calibration test according to an embodiment of the present disclosure.

FIG. 6b shows a relative error between the calculation result and an actual value of the lubrication film thickness in the calibration test according to an embodiment of the present disclosure.

FIG. 7 is a schematic diagram of a computer device according to an embodiment of the present disclosure.

FIG. 8 is a block diagram of an electronic device according to an embodiment of the present disclosure.

In the figures: 1, micrometer screw gauge; 2, upper nut; 3, clamping component; 4, lower nut; 5, moving steel column; 6, calibration block; 60, computer device; 61, processor; 62, memory; 63, computer program; 600, electronic device; 610, processing unit; 620, storage unit; 6201, random access storage unit; 6202, cache storage unit; 6203, read-only storage unit; 6204, program/utility tool; 6205, program module; 630, bus; 640, display unit; 650, input/output interface; 660, network adapter; and 700, external device.

### DETAILED DESCRIPTION OF EMBODIMENTS

The technical solutions of the embodiments of the present disclosure will be clearly and completely described with reference to the accompanying drawings of the embodiments of the present disclosure. It is obvious that described herein are only some embodiments of the present disclosure, rather than all embodiments. Based on the embodiments of the present disclosure, other embodiments obtained by those of ordinary skill in the art without making creative effort shall fall within the scope of the present disclosure.

In the description of the present disclosure, it should be understood that the terms “comprise” and “include” indicate the presence of the described features, entities, steps, operations, elements, and/or components, but do not exclude the presence or addition of one or more other features, entities, steps, operations, elements, components, and/or a combination thereof.

It should also be understood that the terms used herein are only for illustrative, rather than limiting the description. As used in the description of the present disclosure and the appended claims, unless otherwise specified, the terms in singular forms, such as “a”, “an” and “the” are intended to include plural forms.

It should also be understood that the term “and/or” used herein includes three solutions, for example, “A” and/or “B” includes solution “A”, solution “B”, and a combination thereof. Technical solutions of individual embodiments can be combined with each other as long as the combined solution can be implemented by those skilled in the art. When a combination of the technical solutions is contradictory or cannot be realized, it should be considered that such a combination does not exist, and is not within the scope of the present disclosure.

It should also be understood that although the terms “first”, “second” and “third” may be used to describe preset ranges, but these preset ranges should not be limited by such terms. These terms are only used for distinguishment, for example, without departing from the scope of the embodiments of the present disclosure, a first preset range may also be referred to as a second preset range, and similarly, a second preset range may also be referred to as a first preset range.

Depending on the context, the term “if” used herein may be interpreted as “when”, “upon”, “in response to determination” or “in response to detection”. Similarly, depending on the context, the phrase “if it is determined” or “if (a stated condition or event) is detected” may be interpreted as “when it is determined”, “in response to determination”, “when detecting (a stated condition or event)” or “in response to detection for (a stated condition or event)”.

The accompanying drawings illustrate schematic structural diagrams according to various embodiments of the present disclosure. These drawings are not drawn to scale, and certain details may be exaggerated for clarity while others may be omitted for simplicity. The shapes, relative sizes, and positional relationships of various regions and layers shown in the drawings are only illustrative. In practice, deviations may exist due to manufacturing tolerances or technical limitations, and those skilled in the art may design regions/layers with different shapes, sizes, and relative positions as actually required.

The present disclosure provides a method for measuring a lubrication film thickness of a sliding bearing based on an ultrasonic proportional coefficient, where sliding bearing includes a runner plate, a liner, a lubrication film and a substrate. A first proportional coefficient between an echo signal reflected from a liner-air interface and an echo signal reflected from a substrate-lining interface is calculated to obtain a comprehensive response coefficient of an acoustic wave in a transition bonding layer between a substrate and a lining. Based on an echo signal reflected from a lubrication film and the echo signal reflected from the substrate-lining interface, a second proportional coefficient is constructed. Based on the second proportional coefficient and the comprehensive response coefficient, a reflection coefficient of the lubrication film is calculated. The lubrication film thickness is calculated through a resonance model method or a composite model method.

In the method provided herein, an ultrasonic sensor is deployed on the substrate to emit ultrasonic pulses and receive individual echo signals, and individual echo signals are subsequently collected by a digital acquisition card. The ultrasonic sensor is excited by an ultrasonic pulse transmitter-receiver.

The method of the present disclosure utilizes a sensor to collect the echo signal reflected from the lubrication film and the echo signal reflected from the substrate-lining interface, so as to construct the second proportional coefficient, and calculates the reflection coefficient of the lubrication film based on the second proportional coefficient and the comprehensive response coefficient. The method of the present disclosure is not affected by change in a bonding force between the sensor and the substrate, solves problems of reference signal changes caused by interference from external factors such as temperature, vibration and pollution, and improves a robustness of the method for measuring the lubrication film thickness of the sliding bearing, which has important engineering significance for long-term and real-time reliable monitoring of the lubrication film thickness of a friction pair of the sliding bearing, so as to characterize the lubrication condition of the bearing.

### Embodiment 1

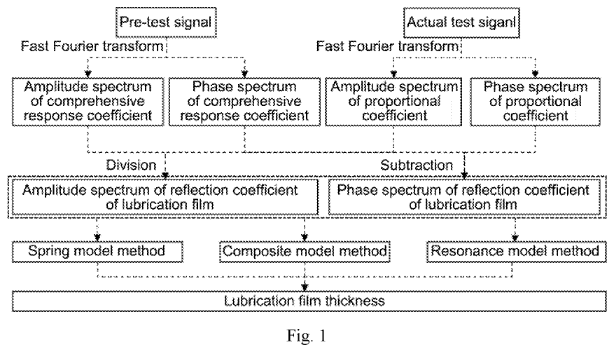

FIG. 1 is a signal processing flowchart of a high-robustness method for measuring a lubrication film thickness of a sliding bearing based on an ultrasonic proportional coefficient. The method for measuring the lubrication film thickness of the sliding bearing based on the ultrasonic proportional coefficient includes the following steps.

(S1) A comprehensive response coefficient CR(f) is constructed.

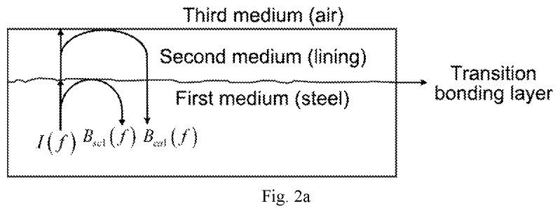

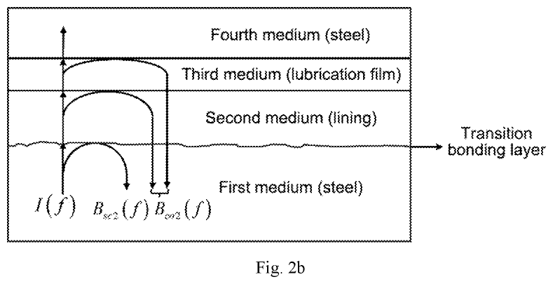

FIGS. 2a-b are schematic diagrams of ultrasonic propagation in a friction pair of the sliding bearing. In a frequency domain, I(f) represents an incident signal. In a pre-test stage, B_{ca1}(f) represents the echo signal reflected from the liner-air interface in the pre-test stage, and B_{sc1}(f) represents the echo signal reflected from the substrate-lining interface in the pre-test stage. Based on the echo signal B_{ca1}(f) reflected from the liner-air interface in the pre-test stage and the echo signal B_{sc1}(f) reflected from the substrate-lining interface in the pre-test stage, a first proportional coefficient K₁(f) is constructed, and an amplitude |K₁(f)| and a phase Φ_{K1}(f) of the first proportional coefficient K₁(f) are obtained. An amplitude spectrum |CR(f)| and a phase spectrum Φ_{CR}(f) of the comprehensive response coefficient CR(f) are further obtained.

The first proportional coefficient K₁(f) is expressed as:

$${K}_{1} ( f ) = \frac{{B}_{ca 1} ( f )}{{B}_{sc 1} ( f )} ;$$

and
the amplitude spectrum |CR(f)| and the phase spectrum Φ_{CR}(f) of the comprehensive response coefficient CR(f) are expressed as:

$$\vert CR ( f ) \vert = \frac{\vert {W}_{sc} \vert \vert {W}_{cs} \vert}{\vert {V}_{s c} \vert} = \frac{\vert {K}_{1} ( f ) \vert}{exp ( - 2 {α}_{c} {d}_{c} )} ; and$$

$${Φ}_{C R} ( f ) = {φ}_{W \_ sc} + {ϕ}_{W \_ cs} - {φ}_{V \_ sc} = {Φ}_{K 1} ( f ) - 2 π f {t}_{c} ;$$

where |W_{sc}| represents an amplitude of a transmission coefficient of the substrate-lining interface; |W_{cs}| represents an amplitude of a transmission coefficient of a lining-substrate interface; α_{c} represents an attenuation coefficient of an ultrasonic wave propagated in the lining; d_{c} represents a thickness of the lining; |V_{sc}| represents an amplitude of a reflection coefficient of the substrate-lining interface; t_{c} represents time of the ultrasonic wave propagated in the lining; φ_{W_sc} represents a phase of the transmission coefficient of the substrate-lining interface; φ_{W_cs} represents a phase of the transmission coefficient of the lining-substrate interface; and φ_{V_sc} represents a phase of the reflection coefficient of the substrate-lining interface.

(S2) A second proportional coefficient K₂(f) is constructed.

FIGS. 2a-b are the schematic diagrams of ultrasonic propagation in the friction pair of the sliding bearing. In an actual testing stage, B_{co2}(f) represents an echo signal reflected from a lubrication film in the actual testing stage, and B_{sc2}(f) represents the echo signal reflected from the substrate-lining interface in the actual testing stage. Based on the echo signal B_{co2}(f) reflected from the lubrication film in the actual testing stage and the echo signal B_{sc2}(f) reflected from the substrate-lining interface in the actual testing stage, the second proportional coefficient K₂(f) is constructed. An amplitude spectrum |K₂(f)| and a phase spectrum Φ_{K2}(f) of the second proportional coefficient K₂(f) are further obtained.

The second proportional coefficient K₂(f) is expressed as:

$${K}_{2} ( f ) = \frac{{B}_{co 2} ( f )}{{B}_{sc 2} ( f )} ;$$

the amplitude spectrum |K₂(f)| and a phase spectrum Φ_{K2}(f) of the second proportional coefficient K₂(f) are expressed as:

$$\vert {K}_{2} ( f ) \vert = \frac{\vert {W}_{s c} \vert \vert {W}_{c s} \vert exp ( - 2 {α}_{c} {d}_{c} ) \vert R ( f ) \vert}{\vert {V}_{s c} \vert} ; and$$

$${Φ}_{K 2} ( f ) = {Φ}_{R} ( f ) + 2 π f {t}_{c} + {φ}_{W \_ sc} + {φ}_{W \_ cs} - {φ}_{V \_ sc} ;$$

where |R(f)| represents an amplitude of a reflection coefficient of the lubrication film; and Φ_{R}(f) represents a phase of the reflection coefficient of the lubrication film.

(S3) The reflection coefficient R(f) of the lubrication film is separated.

Based on the comprehensive response coefficient CR(f) obtained in step (S1) and the second proportional coefficient K₂(f) obtained in step, the amplitude |R(f)| and the phase Φ_{R}(f) of reflection coefficient R(f) of the lubrication film are separated.

The amplitude spectrum |R(f)| and the phase spectrum Φ_{R}(f) of reflection coefficient R(f) of the lubrication film are expressed as:

$$\vert R ( f ) \vert = \frac{\vert {K}_{2} ( f ) \vert}{\vert CR ( f ) \vert exp ( - 2 {α}_{c} {d}_{c} )} ; and$$

$${Φ}_{R} ( f ) = {Φ}_{K 2} ( f ) - 2 π f {t}_{c} - {Φ}_{C R} ( f ) .$$

(S4) The lubrication film thickness is measured.

Based on characteristics of the reflection coefficient of the lubrication film obtained in step (S3), a resonance model method or a composite model method is selected to calculate the lubrication film thickness.

When a minimal value point occurs in the amplitude spectrum of the |R(f)| of the reflection coefficient of the lubrication film or a zero-crossing point of the phase spectrum Φ_{R}(f) of the reflection coefficient of the lubrication film, the lubrication film thickness h is calculated based on the resonance model method, and is expressed as:

$$h = \frac{{c}_{o} m}{2 {f}_{m}} ;$$

where m represents a resonance order; fₘ represents a frequency at the minimal value point or the zero-crossing point; and cₒ represents a speed of an ultrasonic wave propagated in a lubrication film.

Otherwise, the lubrication film thickness h is calculated based on the composite model method, and is expressed as:

$$h = h ( \vert R ( f ) \vert , {Φ}_{R} ( f ) ) = - \frac{{c}_{o}}{4 π f} arg ( \frac{\vert R ( f ) \vert \cdot {e}^{i {Φ}_{R} ( f )}}{{V}_{o s} ( 1 + {V}_{c o} \cdot \vert R ( f ) \vert \cdot {e}^{i {Φ}_{R} ( f )} )} ) = - \frac{{c}_{o}}{4 π f} atan ( \frac{\vert R ( f ) \vert \cdot sin ( {Φ}_{R} ( f ) ) \cdot ( 1 - {V}_{c o}^{2} )}{\begin{matrix}- {V}_{c o} - {\vert R ( f ) \vert}^{2} \cdot {V}_{c o} + \vert R ( f ) \vert \cdot cos ( {Φ}_{R} ( f ) ) + \\ \vert R ( f ) \vert \cdot cos ( {Φ}_{R} ( f ) ) \cdot {V}_{c o}^{2}\end{matrix}} ) ;$$

where V_{co} represents a reflection coefficient of a lining-lubrication film interface; and Vₒₛ represents a reflection coefficient of a lubrication film-runner plate interface.

The calculated lubrication film thickness is compared with a preset thickness threshold. When the calculated lubrication film thickness is lower than the preset thickness threshold, a warning is issued to the user, and a preventive maintenance is performed for the sliding bearing.

It can be understood by those skilled in the art that aspects of the present disclosure can be implemented as a system, method, or a program product. Therefore, the aspects of the present disclosure can be implemented in the following forms: complete hardware, complete software including firmware and microcode, or a combination of hardware and software, which may collectively be referred to herein as a “circuit”, a “module” or a “platform”.

### Embodiment 2

A system for measuring an ultrasonic proportional coefficient of a lubrication film thickness of a sliding bearing is provided. The system can be used to implement the above method for measuring the lubrication film thickness of the sliding bearing based on the ultrasonic proportional coefficient. The system includes a coefficient module, a construction module, a separation module and an output module.

The coefficient module is configured to calculate a first proportional coefficient between an echo signal reflected from a liner-air interface and an echo signal reflected from a substrate-lining interface, and obtain a comprehensive response coefficient of an acoustic wave in a transition bonding layer between a substrate and a lining.

The construction module is configured to construct a second proportional coefficient based on an echo signal reflected from a lubrication film and the echo signal reflected from the substrate-lining interface.

The separation module is configured to separate a reflection coefficient of the lubrication film into an amplitude spectrum and a phase spectrum of the lubrication film based on the second proportional coefficient and the comprehensive response coefficient.

The output module is configured to calculate the lubrication film thickness based on the amplitude spectrum and the phase spectrum of the lubrication film.

Individual modules can be implemented by a processor.

### Embodiment 3

A terminal device includes a processor and a memory. The memory is configured to store a computer program. The computer program includes a program instruction. The processor is configured execute the program instruction stored in a computer storage medium. The processor can be a central processing unit (CPU), a general-purpose processor, a graphics processing unit (GPU), a tensor processing unit (TPU), a digital signal processor (DSP), an application specific integrated circuit (ASIC), a field-programmable gate array (FPGA) and a programmable logic device including a discrete gate or transistor logic device, a data processing logic device based on quantum computing and a discrete hardware component. The processor serves as a computing core and control core of the terminal device, which is adapted to implement one or more instructions, and is specifically adapted to load and execute one or more instructions so as to carry out corresponding method steps or corresponding functions. The processor in this embodiment can be used to implement the method for measuring the lubrication film thickness of the sliding bearing based on the ultrasonic proportional coefficient. Such method includes the following steps.

A first proportional coefficient between an echo signal reflected from a liner-air interface and an echo signal reflected from a substrate-lining interface is calculated to obtain a comprehensive response coefficient of an acoustic wave in a transition bonding layer between a substrate and a lining. Based on an echo signal reflected from a lubrication film and the echo signal reflected from the substrate-lining interface, a second proportional coefficient is constructed. Based on the second proportional coefficient and the comprehensive response coefficient, a reflection coefficient of the lubrication film is separated into an amplitude spectrum and a phase spectrum of the reflection coefficient of the lubrication film. Based on the amplitude spectrum and the phase spectrum of the reflection coefficient of the lubrication film, the lubrication film thickness is calculated.

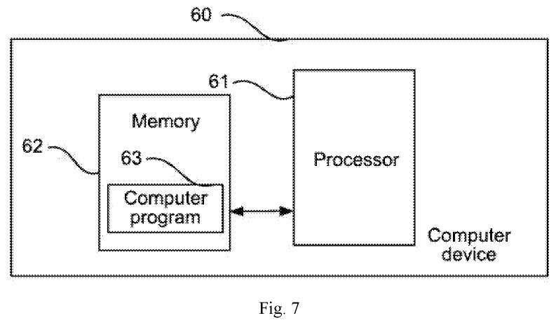

Referring to FIG. 7, the terminal device is a computer device. The computer device 60 includes a processor 61, a memory 62, and a computer program 63 stored in the memory 62 and can be executed in the processor 61. When the processor 61 executes the computer program 63, the steps of the method for measuring the lubrication film thickness of the sliding bearing based on the ultrasonic proportional coefficient above are realized, which are not described in detail herein for brevity. Or when the processor 61 executes the computer program 63, functions of models/units in the system for measuring the ultrasonic proportional coefficient of the lubrication film thickness of the sliding bearing above are realized, which are not described in detail herein for brevity.

The computer device 60 can be a desktop computer, a laptop, a handheld computer, a cloud server, or other computing equipment. The computer device 60 includes but not limited to the processor 61 and the memory 62. It can be understood by those skilled in the art that FIG. 7 is a schematic diagram of the computer device 60 which is not intended to limit the computer device 60, and FIG. 7 can include more or fewer components than those illustrated, some combined components or other different components, for example, the computer device 60 can further include an input/output device, a network access device and a bus.

The processor 61 can be the central processing unit (CPU), the general-purpose processor, the graphics processing unit (GPU), the tensor processing unit (TPU), the digital signal processor (DSP), the application specific integrated circuit (ASIC), the field-programmable gate array (FPGA) and the programmable logic device including the discrete gate or transistor logic device, the data processing logic device based on quantum computing and the discrete hardware component. The general-purpose processor can be a microprocessor or any conventional processor.

The memory 62 can be an internal storage unit of the computer device 60, such as a hard disk or an internal storage of the computer device 60. The memory 62 can also be an external storage device of the computer device 60, such as a plug-in hard disk, a smart media card (SMC), a secure digital (SD) card, and a flash card.

In an embodiment, the memory 62 can include the internal storage unit of the computer device 60 and the external storage device. The memory 62 is configured to store the computer program and other programs and data required by the computer device. The memory 62 is also configured to temporarily storing data that has been output or is to be output.

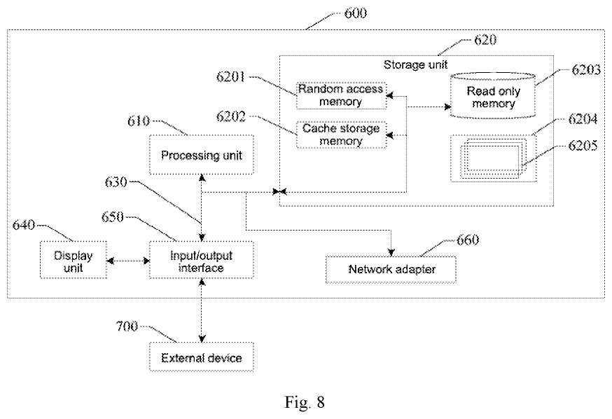

Referring to FIG. 8, the terminal device is an electronic device, which is in a form of a general-purpose computing device. The electronic device includes but not limited to at least one processing unit 610, at least one storage unit 620, a bus 630 for connecting different platform components (including the at least one storage unit 620 and the at least one processing unit 610), and a display unit 640.

In an embodiment, the storage unit stores the program code. The program code can be executed by the at least one processing unit 610, so that the at least one processing unit 610 executes steps in the embodiments corresponding to the above ultrasonic method. For example, the at least one processing unit 610 can execute steps shown in FIG. 1.

The at least one storage unit 620 includes a readable medium in a form of volatile memory, such as random access memory (RAM) 6201 and/or cache memory 6202. In an embodiment, the at least one storage unit 620 includes a read-only memory (ROM) 6203.

The at least one storage unit 620 further includes a program/utility 6204 including a set (at least one) of program modules 6205. Such program module 6205 include but not limited to an operation system, one or more application programs, other program modules, and program data. Each of these examples or some combination thereof may include an implementation of a network environment.

The bus 630 represents one or more types of bus structures, including a memory unit bus, a memory unit controller, a peripheral bus, an accelerated graphics port, a processing unit, or a local bus that uses any of the types of bus structures.

The electronic device 600 is communicated with one or more external devices 700 including a keyboard, a pointing device, and a Bluetooth device. The electronic device 600 is also communicated with one or more devices that enable a user to interact with the electronic device 600, and/or one or more devices that enable the electronic device 600 to communicate with other computing devices (such as a router and a modem) that enable the electronic device 600 to communicate with one or more other computing devices, where communication therebetween can be realize through an input/output (I/O) interface 650. In addition, the electronic device 600 is communicated with one or more network, such as a local area network (LAN), a wide area network (WAN), and/or a public network including the Internet, via a network adapter 660. The network adapter 660 is communicated with other communication module of the electronic device 600 through the bus 630. It should be noted that other hardware and/or software modules can be used based on the electronic device 600 though not shown in the figure, and the hardware and/or software include but not limited to a microcode, a device driver, a redundant processing unit, an external disk drive array, a redundant array of independent disk (RAID) system, a tape drive and a data backup storage platform.

### Embodiment 4

The present disclosure also provides a storage medium, specifically a computer-readable storage medium. The computer-readable storage medium is a memory device in a terminal device, which is configured to store a program and data. It can be understood that the computer-readable storage medium herein includes a built-in storage medium in the terminal device, an expandable storage medium supported by the terminal device, and any tangible medium that contains or stores a program, where the program is configured to be used by an instruction execution system, apparatus, device or a combination thereof. The computer-readable storage medium provides storage space for an operation system of the terminal device. In addition, the storage space further stores one or more instructions adapted to be loaded and executed by the processor, such instructions can be one or more computer programs (including program codes). It should be noted that specific examples (a non-exhaustive list) of the computer-readable storage medium herein include: an electrical connection with one or more wires, a portable disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device and a combination thereof.

The computer-readable storage medium further includes a data signal propagated in a baseband or as a part of a carrier wave, which carries readable program codes. Such data signal propagates in various forms including but not limited to an electromagnetic signal, an optical signal and a combination thereof. The computer-readable storage medium can also be any other readable medium, and the readable medium is configured to send, propagate, or transmit a program configured to be used by an instruction execution system, apparatus, device or a combination thereof. A program code contained on the readable medium can be transmitted via any suitable medium, including but not limited to wireless, wireline, optical fiber cable, radio frequency (RF) and a combination thereof.

A program code for performing operations of the present disclosure can be written by one or more programming languages or a combination thereof. The programming languages include object-oriented programming languages, such as Java and C++, and conventional procedural programming languages, such as “C” programming language or similar programming languages. The program code can be executed completely on a user's computer, partly on the user's computer, as an independent software package, partly on the user's computer and partly on a remote computer, or completely on the remote computer or server. In response to a case that the remote computer is involved, the remote computer can be connected with the user's computer via any network including local area network (LAN) and a wide area network (WAN), or the remote computer can be connected with an external computer, for example, via the Internet using an Internet service provider.

The one or more instructions stored in the computer-readable storage medium can be loaded and executed by the processor, so as to realize corresponding steps of the ultrasonic method for simultaneously measuring coating and lubrication film thicknesses in the above embodiments. The one or more instructions stored in the computer-readable storage medium can be loaded and executed by the processor to perform the following steps.

A first proportional coefficient between an echo signal reflected from a liner-air interface and an echo signal reflected from a substrate-lining interface is calculated to obtain a comprehensive response coefficient of an acoustic wave in a transition bonding layer between a substrate and a lining. Based on an echo signal reflected from a lubrication film and the echo signal reflected from the substrate-lining interface, a second proportional coefficient is constructed. Based on the second proportional coefficient and the comprehensive response coefficient, a reflection coefficient of the lubrication film is separated into an amplitude spectrum and a phase spectrum of the reflection coefficient of the lubrication film. Based on the amplitude spectrum and the phase spectrum of the reflection coefficient of the lubrication film, the lubrication film thickness is calculated.

The database in the embodiments of the present disclosure includes a relational database, a non-relational database and a combination thereof. The non-relational database includes but not limited to a blockchain-based distributed database. The processor in the embodiments of the present disclosure includes but not limited to the general-purpose processor, the central processor, the graphics processor, the DSP, the programmable logic device and the data processing logic device based on quantum computing.

To make the objects, technical solutions and advantages of the present disclosure more clearly, the technical solutions of the present disclosure will be clearly and completely described below with reference to the accompanying drawings. It is obviously that described herein are only some embodiments of the present disclosure, rather than all embodiments. The components described in the accompanying drawings and shown in the embodiments of the present disclosure can be arranged and designed in various different configurations. Therefore, detailed description of the embodiments of the present disclosure is not intended to limit the scope of this application defined by the appended claims, but merely represents selected embodiments of the present disclosure. Based on the embodiments of the present disclosure, other embodiments obtained by those of ordinary skill in the art without making creative effort shall fall within the scope of the present disclosure.

### Experimental Verification Example

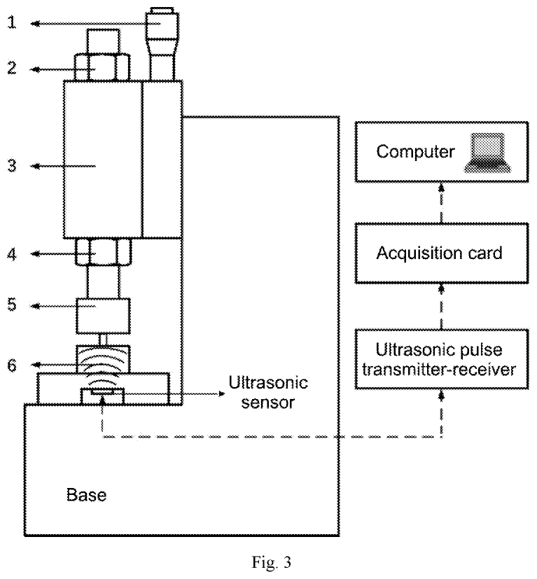

Referring to FIG. 3, a calibration test bench for a lubrication film thickness is used to verify effectiveness of the method. An experimental setup of the calibration test bench includes a displacement platform for adjusting the lubrication film thickness and an ultrasonic measurement system. The displacement platform includes a micrometer screw gauge 1, an upper nut 2, a clamping component 3, a lower nut 4, a moving steel column 5 and a calibration block 6. The calibration block 6 is mounted on a base. An ultrasonic sensor is mounted on a bottom of the calibration block 6 through a high-temperature adhesive. The moving steel column 5 is connected with the clamping component 3 through the upper nut 2 and the lower nut 4.

A small cylinder with a diameter of 5 mm and a thickness of 5 mm is machined on the calibration block 6, so as to reduce a surface tension of the lubricating film and form a relative thinner film. The small cylinder is coated with a babbitt alloy lining with a thickness of 2 mm. A lubricating oil is applied onto the small cylinder, then the micrometer screw gauge 1 is adjusted to change the lubrication film thickness. A height adjustment range of the micrometer screw gauge 1 is 0-18 mm, and a resolution of the micrometer screw gauge 1 is 10 μm.

The ultrasonic measurement system includes the ultrasonic sensor, an ultrasonic pulse transmitter-receiver, a digital acquisition card, and a computer. The ultrasonic pulse transmitter-receiver controls the ultrasonic sensor to emit an ultrasonic wave. When the ultrasonic wave propagates into structures including the calibration block 6 and a lubricating oil layer, and reflection and transmission occur at each interface, and echo signals reflected from each interface are collected by the digital acquisition card and then transmitted to the computer for data processing.

First, in a pre-test stage, an echo signal reflected in an air state is collected and is designated as a first signal.

An echo signal reflected from a lining-air interface in the first signal is designated as B_{ca1}(f), and an echo signal reflected from a substrate-lining interface in the first signal is designated as B_{sc1}(f). Based on the echo signal B_{ca1}(f) reflected from the lining-air interface and the echo signal B_{sc1}(f) reflected from the substrate-lining interface, a first proportional coefficient K₁(f) is constructed, and an amplitude spectrum |K₁(f)| and a phase spectrum Φ_{K1}(f) of the first proportional coefficient K₁(f) are obtained. An amplitude spectrum |CR(f)| and a phase spectrum Φ_{CR}(f) of a comprehensive response coefficient are further obtained.

The calibration block 6 is placed into a heating box and heated to 80° C., following by natural cooling to simulate change in a bonding force between the ultrasonic sensor and the substrate.

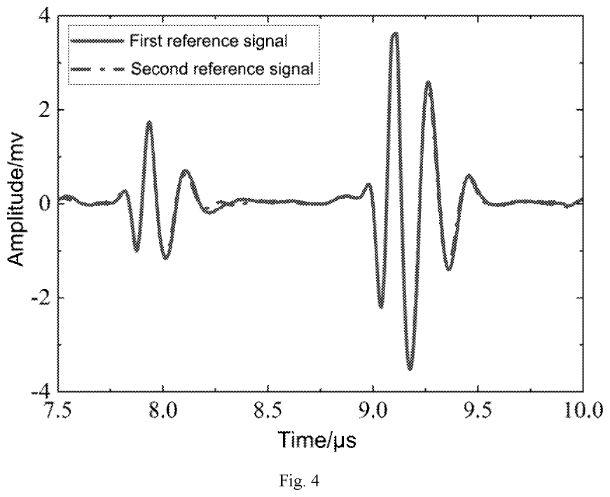

After the calibration block 6 is cooled to a room temperature. The echo signal reflected in the air state is collected and is designated as a second signal. FIG. 4 shows time-domain waveforms of the first reference signal and the second reference signal, it can be observed that after the bonding force between the ultrasonic sensor and the substrate changes, the reference signals vary accordingly. Therefore, when the lubrication film thickness is calculated through the conventional method based on the reference, a new reference signal must be collected before each test to obtain an accurate result. To demonstrate the high robustness of the method of the present disclosure, the lubrication film thickness will subsequently be calculated through the method of the present disclosure based on the first reference signal.

The calibration block 6 is arranged on the calibration test bench for calibration test. The lubricating oil is dropped onto the small cylinder. The micrometer screw gauge 1 is adjusted to generated a lubrication film in a resonance model area, which is designated as a reference. Then the lubrication film thickness is reduced from the resonance model area into a spring model area through the micrometer screw gauge 1, during this process, a difference between an initial lubrication film thickness and a displacement increment of the micrometer screw gauge 1 is designated as an actual lubrication film thickness. An echo signal reflected from each lubrication film thickness is recorded. In the calibration test, the echo signal reflected from the lubrication film is designated as B_{co2}(f), and the echo signal B_{sc2}(f) reflected from the substrate-lining interface is designated as B_{sc2}(f). Then based on the echo signal B_{co2}(f) reflected from the lubrication film and the echo signal B_{sc2}(f) reflected from the substrate-lining interface, a second proportional coefficient K₂(f) is constructed, and an amplitude spectrum |K₂(f)| and a phase spectrum Φ_{K2}(f) of the second proportional coefficient K₂(f) are obtained.

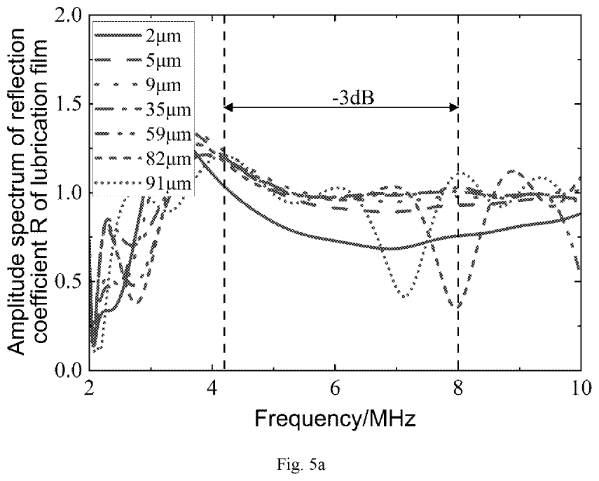

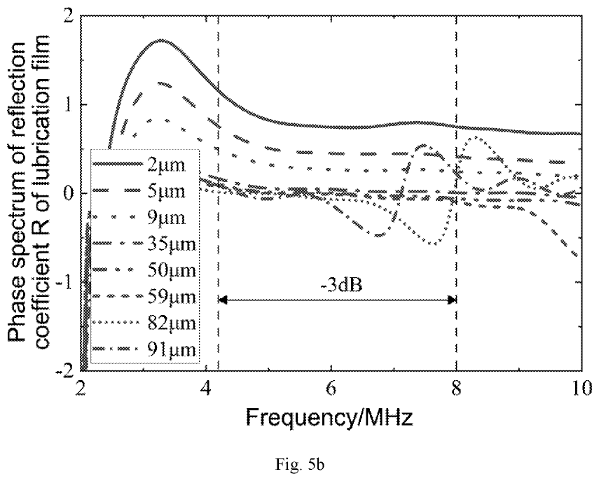

Based on the comprehensive response coefficient obtained in the pre-test stage and the second proportional coefficient K₂(f) obtained in the calibration test, an amplitude and a phase of a reflection coefficient of the lubrication film are calculated. Calculation results are shown in FIGS. 5a-b. FIG. 5a is the amplitude spectrum of the reflection coefficient of the lubrication film. FIG. 5b is the phase spectrum of the reflection coefficient of the lubrication film.

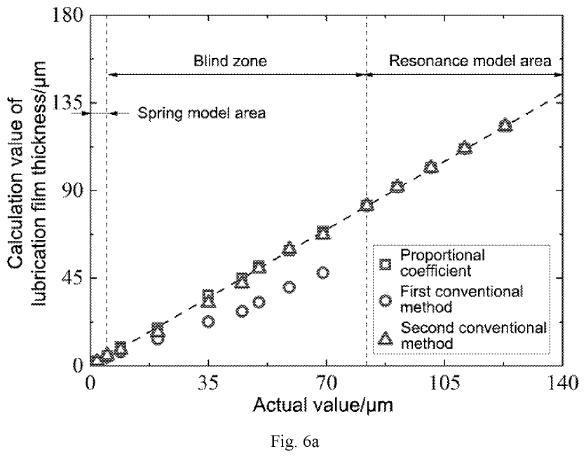

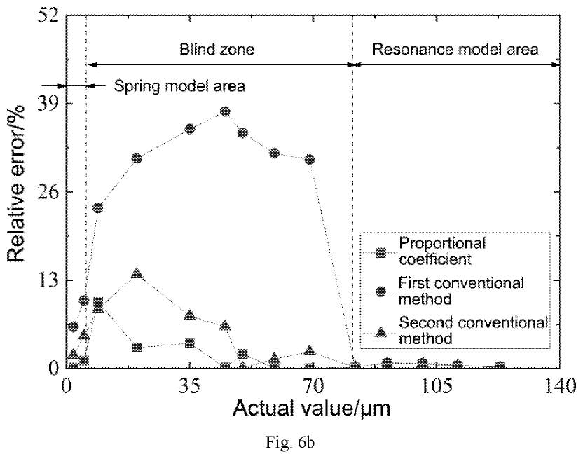

Based on the characteristics of the amplitude spectrum and the phase spectrum of the reflection coefficient of the lubrication film, a resonance model method or a composite model method is selected to calculate the lubrication film thickness. FIG. 6a shows a calculation result of the lubrication film thickness in the calibration test, and FIG. 6b shows a relative error between the calculation result and an actual value of the lubrication film thickness in the calibration test. In FIGS. 6a-b, a first conventional method represents the calculation result and the relative error based on the first reference signal, and a second conventional method represents the calculation result and the relative error based on the second reference signal. It can be observed that the lubrication film thickness calculated based on the method of the present disclosure exhibits strong agreement with the actual values with relatively small errors. When the lubrication film thickness lies within the spring model area, the relative error remains within 2%; when the lubrication film thickness lies within a blind zone, the relative error of 86% of result data remains within 5%, and a maximum relative error is 10%; when the lubrication film thickness lies within the resonance model area, the relative error remains within 1%, which achieves is basically consistent with the accuracy of the calculation result of the lubrication film thickness after updating the reference signal, indicating that this method can maintain the same accuracy as the conventional methods. When the lubrication film thickness is calculated through the conventional methods, if the reference signal is not updated, the relative error of 77% of the data outside the resonance model area is greater than 20%, and the maximum relative error reach 38%, which shows bad consistence between the calculation result and the actual value. It indicates that the method of the present disclosure has a good ability to resist changes in the bonding force between the ultrasonic sensor and the substrate, and has strong anti-interference ability. Therefore, the method of the present disclosure has high robustness in the measurement of lubrication film thickness.

In summary, the present disclosure provides the method and system for measuring the lubrication film thickness of the sliding bearing based on the ultrasonic proportional coefficient. The present disclosure utilizes the ultrasonic sensor to collect the echo signal reflected from the lubrication film and the echo signal reflected from the substrate-lining interface, so as to construct the second proportional coefficient, and calculates the reflection coefficient of the lubrication film based on the second proportional coefficient and the comprehensive response coefficient. The present disclosure is not affected by change in the bonding force between the ultrasonic sensor and the substrate, solves problems of reference signal changes caused by interference from external factors such as temperature, vibration and pollution, and improves the robustness of the method for measuring the lubrication film thickness of the sliding bearing, which has important engineering significance for long-term reliable monitoring of the lubrication film thickness of a friction pair of the sliding bearing.

In can be clearly understood by those skilled in the art that for the convenience and conciseness of description, the division of the functional units and modules is merely illustrative. In practical applications, the above function can be allocated to be completed by different functional units and modules as needed, that is, an internal structure of the device is divided into different functional units or modules to complete all or part of the above functions. The functional units and modules in the embodiments can be integrated into one processing unit, or each of the functional units and modules can separately exist as an independent physical entity, or two or more functional units and modules are integrated into one unit. The integrated unit can be implemented in the form of hardware or as software functional units. In addition, specific names of the functional units and modules are only for distinguishing from each other and are not intended to limit the scope of this application defined by the appended claims. For specific working processes of the units and modules in the above system, reference can be made to corresponding processes in embodiments of the method, which is not reiterated herein.

In the above embodiments, description of each embodiment has its own focus. For parts that are not elaborated or recorded in a certain embodiment, reference can be made to relevant descriptions in other embodiments.

In can be understood by those skilled in the art that the units and algorithm steps in the embodiments of the present disclosure can be implemented in electronic hardware, or a combination of computer software and electronic hardware. Whether these functions are performed in hardware or software depends on the specific application and design constraints of the technical solutions. Those skilled in the art can use different methods to implement the described functions for each particular application, but such implementation should not be considered beyond the scope of this application.

In the embodiments of the present disclosure, it should be understood that the disclosed devices/terminal and method can be implemented in other manners. For example, the devices/terminal in the embodiments are only illustrative. For example, the division of modules or units is only based on logical functionality, and can be divided in other manners in practical implementation. For example, multiple units or components can be combined or integrated into another system, or some features can be omitted or not executed. Besides, mutual couplings, direct couplings or communication connections shown or discussed can be indirectly coupled or communicated through some interfaces, apparatuses, or units, in the form of electrical, mechanical, or in other forms.

The units as separate components can be physically separated or not, and the components displayed as units can be physical units or not, that is, the components can be located in one place, or distributed across multiple network units. Some or all of these units can be selected according to actual needs to achieve the objects of the embodiments.

In addition, the functional units in the various embodiments of the present disclosure can be integrated into one processing unit, or each unit can exist as a separate physical entity, or two or more units can be integrated into one unit. The integrated units can be implemented in the form of hardware or software functional units.

The integrated modules/units, if implemented in the form of software functional units and sold or used as independent products, can be stored in a computer-readable storage medium. Based on this understanding, all or part of the processes in the embodiments of the method of the present disclosure can be completed via corresponding hardware instructed by the computer program. The computer program can be stored in the computer-readable storage medium. When the computer program is executed by the processor, the steps in the embodiments of the method can be realized. In an embodiment, the computer program includes computer program code, which can be the form of source code, object code, an executable file, or certain intermediate forms. The computer-readable medium may include any entity or device, recording medium, USB flash drive, removable hard disk, magnetic disk, optical disk, computer memory, read-only memory (ROM), random access memory (RAM), electrical carrier signals, telecommunications signals, and software distribution media that can carry the computer program code. It should be noted that the content included in the computer-readable medium can be appropriately increased or decreased according to the requirements of legislation and patent practice in a judicial jurisdiction. For example, in some jurisdictions, under legislation and patent practice, the computer-readable storage medium does not include electrical carrier signals and telecommunications signals.

This application is described with reference to flowcharts and/or block diagrams of methods, devices, and computer program products according to embodiments of the present disclosure. It should be understood that each process and/or block in the flowcharts and/or block diagrams, and a combination thereof can be implemented by computer program instructions. These computer program instructions can be provided to a general-purpose computer, a dedicated computer, an embedded processor, or other programmable data processing devices to configure a machine. This machine, when operated by the computer or other programmable data processing devices, produces an apparatus that performs the functions specified in one or more processes of the flowchart and/or one or more blocks of the block diagram.

These computer program instructions can also be stored in a computer-readable storage medium that can be used to configure a computer or other programmable data processing device to operate in a specific manner. The instructions stored in the computer-readable storage medium produce an article of manufacture that includes the instructions, and implements the functions specified in one or more processes of the flowchart and/or one or more blocks of the block diagram.

The computer program instructions can also be loaded onto a computer or other programmable data processing devices, causing the computer or other programmable devices to execute a series of operational steps to produce a machine-implemented process. As a result, the instructions executed by the computer or other programmable devices provide steps for performing the functions specified in one or more processes of the flowchart and/or one or more blocks of the block diagram.

Described above are only for illustrating the technical ideas of the present disclosure, which is not intended to limit the scope of this application. Any modification made on the basis of the technical solutions according to the technical ideas of the present disclosure shall fall within the scope of this application defined by the appended claims.

What is claimed is:

1. A method for measuring a lubrication film thickness of a sliding bearing based on an ultrasonic proportional coefficient, the sliding bearing comprising a runner plate, a liner, a lubrication film and a substrate, and the method comprising:
calculating a first proportional coefficient, wherein the first proportional coefficient is a proportional coefficient between an echo signal reflected from a liner-air interface and an echo signal reflected from a substrate-liner interface; and based on the first proportional coefficient, obtaining a comprehensive response coefficient of an acoustic wave in a transition bonding layer between the substrate and the liner;
based on an echo signal reflected from the lubrication film and the echo signal reflected from the substrate-liner interface, constructing a second proportional coefficient;
based on the second proportional coefficient and the comprehensive response coefficient, obtaining a reflection coefficient of the lubrication film; and dividing the reflection coefficient of the lubrication film into an amplitude spectrum of the reflection coefficient of the lubrication film and a phase spectrum of the reflection coefficient of the lubrication film; and
based on the amplitude spectrum and the phase spectrum, calculating a thickness of the lubrication film.

2. The method of claim 1, wherein the comprehensive response coefficient is obtained through steps of:
removing the lubrication film from the sliding bearing, and collecting the echo signal B_{ca1}(f) reflected from the liner-air interface;
based on the echo signal B_{ca1}(f) and the echo signal B_{sc1}(f) reflected from the substrate-liner interface, constructing a third proportional coefficient K₁(f); obtaining an amplitude spectrum |K₁(f)| of the third proportional coefficient K₁(f) and a phase spectrum Φ_{K1}(f) of the third proportional coefficient K₁(f); and obtaining an amplitude spectrum |CR(f)| of the comprehensive response coefficient and a phase spectrum Φ_{CR}(f) of the comprehensive response coefficient.

3. The method of claim 2, wherein the amplitude spectrum |CR(f)| of the comprehensive response coefficient and the phase spectrum Φ_{CR}(f) of the comprehensive response coefficient are respectively expressed as:
$$\vert CR ( f ) \vert = \frac{\vert {W}_{sc} \vert \vert {W}_{cs} \vert}{\vert {V}_{s c} \vert} = \frac{\vert {K}_{1} ( f ) \vert}{exp ( - 2 {α}_{c} {d}_{c} )} ; and$$
$${Φ}_{C R} ( f ) = {φ}_{W \_ sc} + {φ}_{W \_ cs} - {φ}_{V \_ sc} = {Φ}_{K 1} ( f ) - 2 π f {t}_{c} ;$$
wherein |W_{sc}| represents an amplitude of a transmission coefficient of the substrate-liner interface; |W_{cs}| represents an amplitude of a transmission coefficient of a liner-substrate interface; α_{c} represents an attenuation coefficient of an ultrasonic wave in the liner; K₁(f) represents the third proportional coefficient; d_{c} represents a thickness of the liner; |V_{sc}| represents an amplitude of a reflection coefficient of the substrate-liner interface; t_{c} represents a propagation time of the ultrasonic wave in the liner; φ_{W_sc} represents a phase of the transmission coefficient of the substrate-liner interface; φ_{W_cs} represents a phase of the transmission coefficient of the liner-substrate interface; and φ_{V_sc} represents a phase of the reflection coefficient of the substrate-liner interface.

4. The method of claim 1, wherein step of constructing the second proportional coefficient based on the echo signal reflected from the lubrication film and the echo signal reflected from the substrate-liner interface comprises:
based on the echo signal B_{co2}(f) reflected from the lubrication film and the echo signal B_{sc2}(f) reflected from the substrate-liner interface, constructing the second proportional coefficient K₂(f), and dividing the second proportional coefficient K₂(f) into an amplitude spectrum |K₂(f)| of the second proportional coefficient K₂(f) and a phase spectrum Φ_{K2}(f) of the second proportional coefficient K₂(f).

5. The method of claim 4, wherein the amplitude spectrum |K₂(f)| and the phase spectrum Φ_{K2}(f) are respectively expressed as:
$$\vert {K}_{2} ( f ) \vert = \frac{\vert {W}_{s c} \vert \vert {W}_{c s} \vert exp ( - 2 {α}_{c} {d}_{c} ) \vert R ( f ) \vert}{\vert {V}_{s c} \vert}$$
$${Φ}_{K 2} ( f ) = {Φ}_{R} ( f ) + 2 π f {t}_{c} + {φ}_{W \_ sc} + {φ}_{W \_ cs} - {φ}_{V \_ sc} ;$$
wherein |R(f)| represents an amplitude of the reflection coefficient of the lubrication film; Φ_{R}(f) represents a phase of the reflection coefficient of the lubrication film; |W_{sc}| represents an amplitude of a transmission coefficient of the substrate-liner interface; |W_{cs}| represents an amplitude of a transmission coefficient of a liner-substrate interface; α_{c} represents an attenuation coefficient of an ultrasonic wave in the liner; d_{c} represents a thickness of the liner; |V_{sc}| represents an amplitude of a reflection coefficient of the substrate-liner interface; f represents a frequency; t_{c} represents a propagation time of the ultrasonic wave in the liner; φ_{W_sc} represents a phase of the transmission coefficient of the substrate-liner interface; φ_{W_cs} represents a phase of the transmission coefficient of the liner-substrate interface; and φ_{V_sc} represents a phase of the reflection coefficient of the substrate-liner interface.

6. The method of claim 1, wherein the amplitude spectrum |R(f)| of the reflection coefficient of the lubrication film and the phase spectrum Φ_{R}(f) of the reflection coefficient of the lubrication film are respectively expressed as:
$$\vert R ( f ) \vert = \frac{\vert {K}_{2} ( f ) \vert}{\vert CR ( f ) \vert exp ( - 2 {α}_{c} {d}_{c} )} ; and$$
$${Φ}_{R} ( f ) = {Φ}_{K 2} ( f ) - 2 π f {t}_{c} - {Φ}_{C R} ( f ) ;$$
wherein |K₂(f)| represents an amplitude spectrum of the second proportional coefficient; Φ_{K2}(f) represents a phase spectrum of the second proportional coefficient; |CR(f)| represents an amplitude spectrum of the comprehensive response coefficient; α_{c} represents an attenuation coefficient of an ultrasonic wave in the liner; d_{c} represents a thickness of the liner; f represents a frequency; t_{c} represents a propagation time of the ultrasonic wave in the liner; and Φ_{CR}(f) represents a phase spectrum of the comprehensive response coefficient.

7. The method of claim 1, wherein the lubrication film thickness is calculated through steps of:
when there is a local minimum point in the amplitude spectrum |R(f)| of the reflection coefficient of the lubrication film or there is a zero-crossing point in the phase spectrum Φ_{R}(f) of the reflection coefficient of the lubrication film, calculating the thickness h of the lubrication film through a resonance model method; and
when there is no local minimum point in the amplitude spectrum |R(f)| of the reflection coefficient of the lubrication film and there is no zero-crossing point in the phase spectrum Φ_{R}(f) of the reflection coefficient of the lubrication film, calculating the thickness h of the lubrication film through a composite model method.

8. The method of claim 7, wherein the resonance model method is expressed as:
$$h = \frac{{c}_{o} m}{2 {f}_{m}}$$
wherein m represents a resonance order; fₘ represents a frequency at the local minimum point or the zero-crossing point; and cₒ represents a propagation speed of an ultrasonic wave in the lubrication film.

9. The method of claim 7, wherein the composite model method is expressed as:
$$h = - \frac{{c}_{o}}{4 π f} atan ( \frac{\vert R ( f ) \vert \cdot sin ( {Φ}_{R} ( f ) ) \cdot ( 1 - {V}_{c o}^{2} )}{\begin{matrix}- {V}_{c o} - {\vert R ( f ) \vert}^{2} \cdot {V}_{c o} + \vert R ( f ) \vert \cdot cos ( {Φ}_{R} ( f ) ) + \\ \vert R ( f ) \vert \cdot cos ( {Φ}_{R} ( f ) ) \cdot {V}_{c o}^{2}\end{matrix}} ) ;$$
wherein V_{co} represents a reflection coefficient of a liner-lubrication film interface; Vₒₛ represents a reflection coefficient of a lubrication film-runner plate interface; cₒ represents a propagation speed of an ultrasonic wave in the lubrication film; and f represents a frequency.

10. A system for measuring a lubrication film thickness of a sliding bearing based on ultrasonic proportional coefficient, comprising:
a first processor;
a second processor;
a third processor; and
a fourth processor;
wherein the first processor is configured to calculate a first proportional coefficient, and obtain a comprehensive response coefficient of an acoustic wave in a transition bonding layer between a substrate and a liner, wherein the first proportional coefficient is a proportional coefficient between an echo signal reflected from a liner-air interface and an echo signal reflected from a substrate-liner interface;
the second processor is configured to construct a second proportional coefficient based on an echo signal reflected from a lubrication film and the echo signal reflected from the substrate-liner interface;
the third processor is configured to divide a reflection coefficient of the lubrication film into an amplitude spectrum and a phase spectrum based on the second proportional coefficient and the comprehensive response coefficient; and
the fourth processor is configured to calculate and output a thickness of the lubrication film based on the amplitude spectrum and the phase spectrum.
